(19) United States
(12) Patent Application Publication
(10) Pub. No.: US 2008/0152300 A1
(43) Pub. Date: Jun. 26, 2008

(54) Systems and methods for inserting advertisements during commercial skip

(75) Inventors: Robert A. Knee, Lansdale, PA (US); Michael L. Craner, Exton, PA (US)

Correspondence Address: ROPES & GRAY LLP, PATENT DOCKETING 39/361, 1211 AVENUE OF THE AMERICAS, NEW YORK, NY, 10036-8704, US

(73) Assignee: Guideworks, LLC, Radnor, PA (US)

(21) Appl. No.: 11/644,119

(22) Filed: Dec. 22, 2006

(51) Int. Cl. H04N 5/91

(52) U.S. Cl. 386/68

(57) ABSTRACT

Systems and methods for skipping advertisements while playing back a video that includes at least one advertisement are provided. When a user reaches the advertisement, the user may select to skip the advertisement. In response to the skip instruction, the interactive media guidance application may identify and display substitute media instead of the advertisement. The substitute media may be an image, a video frame, a video clip, a graphic, or any other suitable media. The interactive media guidance application may identify the substitute media to display from advertisement data associated with the skipped advertisement. The substitute media may be displayed for a designated length of time (e.g., less than the time it would take to fast forward past the advertisement). Once the time for displaying the substitute media has lapsed, the interactive media guidance application may resume playback of the video following the end of the advertisement.

### BACKGROUND OF THE INVENTION

This invention is directed to systems and methods for skipping commercials and advertisements when playing back recorded media in video or audio entertainment systems.

Interactive media guidance applications, such as interactive television program guides, are well known in the art. Using interactive media guidance applications, users may select and record content that is provided by content providers (e.g., broadcast programs) using a recording device. When a user plays back a recording, the recording includes a recorded program and commercials distributed with the program. Some systems have allowed the user to avoid commercials using fast forward or skip features. Such features, however, decrease or eliminate the intended effect of the commercial. As a result, some advertisers have resisted these features because such features waste their advertising dollars.

Some compromise approaches have been proposed by manufacturers. In one such approach, sometimes referred to as a “speed bump” feature, the advertiser's logo is displayed while the user fast-forwards through a commercial. A fast-forward based feature such as this, however, requires that the user still wait the full time that it takes for the program to fast-forward. Being subjected to advertisement graphics for that time may be objectionable to some users.

Unlike fast forward, commercial skip is nearly instantaneous; it “jumps” the user over, or to the end of, a commercial, typically following the pressing of a single button or selection of a single command. Thus there is no time for the insertion of a graphic, nor is there any visual representation or indicator of the skipped-over commercial. This makes it particularly undesirable to advertisers. Its speed and convenience, however, is very desirable to users.

Accordingly, it is desirable to provide systems and methods for skipping advertisements while still displaying substitute advertising media.

### SUMMARY OF THE INVENTION

In accordance with the principles of the present invention, systems and methods for skipping advertisements while displaying substitute media instead of the advertisement, are provided. For purposes of clarity, and not by way of limitation, the present invention may sometimes be described in the context of providing advertisement skipping functions in videos, such as television programs. It will be understood, however, that the principles of the present invention may be applied to skipping portions of a media for any other suitable media (e.g., audio).

A user may play back a video that is at least partially stored on a storage device, where the partially stored video includes at least one advertisement. For example, the user may direct the interactive media guidance application to play back a program partially or entirely recorded on a recording device. As another example, the user may direct the interactive media guidance application to play back videos that have been cached (e.g., in connection with trick play functions such as pause and rewind). As still another example, the user may direct the interactive media guidance application to play back an on-demand video that is stored by an on-demand server.

In some embodiments, data sources associated with the interactive media system may provide interactive media guidance data associated with the video to the interactive media guidance application. The interactive media guidance data may include advertisement data that is associated with the advertisement of the video and provided in band or out of band or in a separate data stream.

The advertisement data associated with the advertisement may comprise or identify substitute media to display when the advertisement is skipped during playback of the video. The advertisement data as well as substitute media identified by the advertisement data may be provided as part of the advertisement stream (e.g., “in-band” to the advertisement video stream), or in a separate or “out-of-band” data stream. In some embodiments, the substitute media may be provided as part of the advertisement data (e.g., the advertisement data may reference itself or a component of itself or another component in the same band). In some embodiments, the advertisement data may provide the interactive media guidance application with a link to substitute media that the interactive media guidance application may access (e.g., a link to substitute media stored in a data source such as a local or network hard drive or Intra/Internet server). The substitute media may include an image (e.g., gif, jpeg, or MPEG I-frame), a video clip or image combined with an application (e.g., java application) for potentially decompressing and displaying the video clip or image, a series of images forming a shortened advertisement, a video clip, a slide show, or any other suitable media.

In response to a user instruction to skip an advertisement while playing back a video, the interactive media guidance application may identify the advertisement data associated with the skipped advertisement. From the advertisement data, the interactive media guidance application may identify the substitute media associated with the advertisement, and display the substitute media instead of the advertisement. The interactive media guidance application may display the substitute media for any suitable length of time. The display time may be less than the time it would take to fast forward past the advertisement so that it is desirable for a user to skip but long enough to at least gain some advertisement benefit (e.g., even if short). In some embodiments, the interactive media guidance application may identify the length of time to display the substitute media from the advertisement data associated with the advertisement. Once the interactive media guidance application has displayed the substitute media for the appropriate display length, the interactive media guidance application may automatically return to the video and continue playback from a point following the end of the advertisement (e.g., from the first video frame following the advertisement).

In some embodiments, the advertisement data may also include interactive media guidance application directions such as, for example, a display length for the substitute media, the display configuration for the substitute media, and whether the user may skip a particular advertisement. The system may include default advertisement data specifying behavior and/or substitute advertisement media for display when advertisement data specific to a particular advertisement is not available.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a diagram of an illustrative interactive media system in accordance with one embodiment of the present invention;

FIG. 2 shows an illustrative display screen showing television listings in accordance with one embodiment of the present invention;

FIG. 3 shows an illustrative display screen showing information relating to a television program in accordance with one embodiment of the present invention;

FIG. 4 shows an illustrative display screen showing a television program in full screen after a recording has commenced in accordance with one embodiment of the present invention;

FIG. 5 shows an illustrative display screen showing recording options in accordance with one embodiment of the present invention;

FIG. 6 shows an illustrative display screen showing recorded programs listings in accordance with one embodiment of the present invention;

FIG. 7 shows an illustrative display screen for playing back a recording in accordance with the principles of the present invention;

FIGS. 8-10 show illustrative display screens for displaying substitute media in response to a skip instruction in accordance with the principles of the present invention.

FIG. 11 shows a flow chart of an illustrative process for displaying substitute media in response to a skip instruction in accordance with one embodiment of the present invention; and

FIG. 12 shows a flow chart of an illustrative process for processing advertisement data in accordance with one embodiment of the present invention.

### DETAILED DESCRIPTION

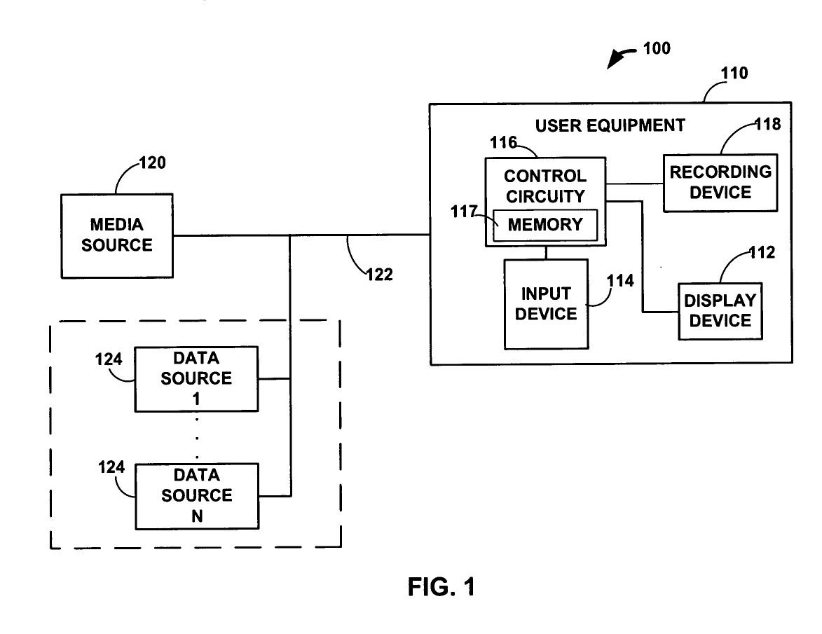

FIG. 1 shows illustrative interactive media system 100 in accordance with one embodiment of the invention. User equipment 110 receives media in the form of signals from media source 120 over communications path 122. In practice there may be multiple media sources 120 and user equipment 110, but only one of each has been shown in FIG. 1 to avoid over-complicating the drawing.

Media source 120 may be any suitable media source such as, for example, a cable system headend, satellite media distribution facility, media broadcast facility, internet protocol television (IPTV) headend, on-demand server (e.g., VOD server), website, game service provider (e.g., for online gaming), or any other suitable facility or system for originating or distributing media. Media source 120 may be configured to transmit signals over any suitable communications path 122 including, for example, a satellite path, a fiber-optic path, a cable path, an Internet path, or any other suitable wired or wireless path. The signals may carry any suitable media such as, for example, television programs, games, music, news, web services, video, or any other suitable media. In some embodiments, media source 120 may include control circuitry for executing the instructions of a trick-play client or an interactive media guidance application such as, for example an online interactive media guidance application.

User equipment 110 may include any equipment suitable for providing an interactive media experience. User equipment 110 may include television equipment such as a television, set-top box, recording device, video player, user input device, or any other device suitable for providing an interactive media experience. For example, user equipment 110 may include a DCT 2000, 2500, 5100, 6208 or 6412 set-top box provided by Motorola, Inc. In some embodiments, user equipment 110 may include computer equipment, such as a personal computer with a television card (PCTV). In some embodiments, user equipment 110 may include a fixed electronic device such as, for example, a gaming system (e.g., X-Box, PlayStation, or GameCube) or a portable electronic device, such as a portable DVD player, a portable gaming device, a cellular telephone, a PDA, a music player (e.g., MP3 player), or any other suitable fixed or portable device.

In the example of FIG. 1, user equipment 110 includes at least control circuitry 116, display device 112, user input device 114, and recording device 118 which may be implemented as separate devices or as a single device. An interactive media guidance application may be implemented on user equipment 110 to provide media guidance functions to the user for media displayed on display device 112. In some embodiments, the interactive media guidance application may be or include an interactive television application, a trick-play client, or any other application fro providing media features to the user.

Display device 112 may be any suitable device such as, for example, a television monitor, a computer monitor, or a display incorporated in user equipment 110 (e.g., a cellular telephone or portable music player display). Display device 112 displays the media transmitted by media source 120 over path 122, and the displays of the trick-play client. Display device 112 may also be configured to provide for the output of audio.

User input device 114 may be any suitable device for interfacing with the interactive media guidance application. For example, user input device 114 may be a remote control, keyboard, mouse, touch pad, touch screen or voice recognition interface. User input device 114 may communicate with user equipment 110 and control circuitry 116 using any suitable communications link. For example, user input device 114 may use an infra-red (IR), radio-frequency, Bluetooth, wireless (e.g., 802.11), wired, or any other suitable communications link.

Recording device 118 may be a personal video recorder (PVR), digital video recorder (DVR), video cassette recorder (VCR), DVD-recorder, compact disc recorder, or any other suitable recording device. In some embodiments, recording device 118 may be a storage device for storing or recording content or data recorded or provided by other components of interactive media system 100 (e.g., a storage device for caching live television programs to enable trick play functions). Recording device 118 may include one or more tuners. For example, recording device 118 may include at least one analog tuner for tuning to a desired analog television channel (e.g., to display video for a given television channel to a user, or to receive interactive media guidance application data and other data). Recording device 118 may include digital decoding circuitry for receiving digital television programming, music programming, interactive media guidance application data, and other data on one or more digital channels. As still another example, recording device 118 may include circuitry for handling both analog and digital channels. Recording device 118 may be configured to cache media as the user receives it with user equipment 110 (e.g., cache the currently tuned channel) to provide trick-play functions for the user.

In some embodiments, recording device 118 may include a processor (e.g., a microcontroller or microprocessor or the like) that is used to receive and execute interactive media guidance application instructions. Recording device 118 may include memory such as random-access memory for use when executing applications. Nonvolatile memory may also be used to store a boot-up routine or other instructions. A hard disk and other storage in recording device 118 may be used to support databases (e.g., interactive media guidance application databases or other interactive media guidance application databases). A hard disk or other storage in recording device 118 may also be used to record media such as television programs or video-on-demand content or other content provided to recording device 118.

In some embodiments, recording device 118 may include IR communications circuitry or other suitable communications circuitry for communicating with a remote control (e.g., with user input device 114). Recording device 118 may also include dedicated buttons and a front-panel display. The front-panel display may, for example, be used to display the current channel to which the recording device is tuned.

In some embodiments, recording device 118 may include communications circuitry such as a cable modem, an ISDN modem, a DSL modem, a telephone modem, or a wireless modem for communications with other equipment. Such communications may involve the Internet or other suitable communications networks or paths. Recording device 302 may also include a satellite receiver or other equipment that has wireless communications circuitry for receiving satellite signals.

In some embodiments, recording device 118 may be a network recording device that is located outside of user equipment 110. In some embodiments, the network recording device may be incorporated in content source 120 (e.g., at the head-end of a cable plant), data source 124, a VOD server (not shown), user equipment 110 (e.g., as a second recording device, or a hard drive on a home computer), an Internet server, or any other suitable device. In some embodiments, the network recording device may be a stand alone device (e.g., a commercial network recording device, or a DVR device in a home or neighborhood network). The network recording device may receive instructions to perform recordings from the interactive media guidance application implemented on any of a plurality of instances of user equipment 110.

Control circuitry 116 is adapted to receive user inputs from input device 114 and execute the instructions of the interactive media guidance application. Control circuitry 116 may include one or more tuners (e.g., analog or digital tuners), encoders and decoders (e.g., MPEG decoders), processors (e.g., Motorola 68000 family processors), memory 117 (i.e., RAM and hard disks), communications circuitry (e.g., cable modem circuitry), input/output circuitry (e.g., graphics circuitry), connections to the various devices of user equipment 110, and any other suitable component for providing analog or digital media programming, program recording, and interactive media guidance features. In some embodiments, control circuitry 116 may be included as part of one of the devices of user equipment 110 such as, for example, part of display 112 or any other device (e.g., a set-top box, television and video player).

In some embodiments, the interactive media guidance application may provide features to the user with a client/server approach. There may be one server for each instance of user equipment 110, one for multiple instances of user equipment 110, or a single server may serve as a proxy for each instance of user equipment 110.

Any suitable number of users may have equipment, such as user equipment 110, connected to media source 120 and data sources 124. But for the clarity of the figure, the equipment of only a single user is shown. The equipment of the plurality of users may be connected to media source 120 and data source 124 using a cable television network, a satellite television network, a local area network (LAN), a wireless network, the Internet (e.g., using a DOCSIS modem), or any other suitable means. In some embodiments, the equipment of the plurality of users may be connected to each other using any suitable means.

User equipment 110 may receive interactive media guidance application data from one or more data sources 124. Data sources 124 may provide data for a particular type of media or for a particular application. For example, one data source 124 may provide data for non-on-demand media (e.g., non-pay and pay-per-view programs), and another may provide data for on-demand media (e.g., VOD programs). Or, for example, a single data source may provide both of these types of data. For example, one data source 124 may provide data for an interactive media guidance application. Another data source 124 may, for example, provide data for another interactive application (e.g., a home shopping application, and real-time data such as sports scores, stock quotes, news data and weather data). In some embodiments, data sources 124 may provide data to the interactive media guidance application using a client/server approach. There may be one server per data source, one for all sources or, in some embodiments, a single server may communicate as a proxy between user equipment 110 and various data sources 124. In some embodiments, data sources 124 may provide data as an online interactive media guidance application. In such embodiments, data source 124 may include control circuitry for executing the instructions of the online media guidance application. In some embodiments, data source 124 may be a storage device for storing or recording content or data recorded or provided by other components of interactive media system 100 or by a content or data provider (e.g., a VOD server).

In some embodiments, data source 124 may provide advertisements (e.g., text, graphics and video advertisements for various programs, products, services, and interactive media guidance application features) to the interactive media guidance application. The advertisements may be provided by a dedicated data source, or the advertisements, along with other data, may be provided by one or more data sources.

FIG. 1 shows media source 120 and data sources 124 as separate elements. In practice, their functionality may be combined and provided from a single system at a single facility, or multiple systems at multiple facilities. For example, one media source 120 and data source 124 may be combined to provide VOD content and associated VOD data. As another example, a separate data source 124 may be associated with each of a plurality of television broadcasters and may provide data that is specific to those broadcasters (e.g., advertisements for future programming of the broadcasters, or logo data for displaying broadcasters' logos in interactive media guidance application display screens).

In some embodiments, the interactive media guidance application data provided by data source 124 or advertisers may include advertisement data associated with the advertisements to the interactive media guidance application. The data source may distribute advertisement data along with the associated advertisements using any suitable technique. For example, advertisement data may be distributed in conjunction with transmitted content or media (e.g., incorporated in-band with the media), distributed separately from the transmitted media (e.g., out-of-band in a data stream that accompanies the media stream), or by any other suitable distribution means. In such an approach, the interactive media guidance application may process the in-band or out-of-band media, or process the data stream to obtain the advertisement data (e.g., extract an identifier, instructions, or a URL from a data component within an MPEG-2 transport stream).

The terminology “in-band” and “out-of-band” originally referred to signaling (e.g., within a radio transmission) that which was within or outside of, respectively, the primary radio frequency band. Today, “band” is understood by one skilled in the art to refer to any primary digital or analog conduit for transmission including a channel, stream, tunnel, socket, circuit, virtual circuit, or path whether wired or wireless. In-band advertisement data would thus be understood to be advertisement data that is carried in the same channel, stream, tunnel, socket, etc., as the advertisement for which it is associated or to any primary content feed to which it is associated. An example of in-band carriage of advertisement data in an IP stream would be opening an IP socket between a sending application and a receiving application, that is used to carry the advertisement data in addition to a primary content stream (e.g., the video stream of advertisement). An example of out-of-band carriage of advertisement data in an MPEG-2 system would be the carriage of the advertisement data in a digital stream that is carried on an analog carrier at a first frequency and the carriage of the advertisement itself on a carrier at a second frequency, different from the first. In MPEG-2, a single service transport stream (that may be part of a multiple service transport stream) is composed of multiple components including a primary video component, a primary audio component and then one or more data components. If the substitute media is carried in one of the primary or secondary video, audio, or data streams, it is considered in-band to the service, if not, it is considered out-of-band to it.

In an MPEG-4 system, in-band advertisement data or substitute media may be carried in a separate video object plane. For ATSC digital video, the concept of the analog vertical blanking interval (VBI) has been expanded to include a digital data in-band VBI equivalent. More information can be found in the International Standard for Organization ISO-13818 standard, entitled Information Technology Generic Coding of Moving Pictures and Associated Audio Information, and the Consumer Electronic Association CEA-708B standard, entitled Digital Television (DTV) Closed Captioning, each incorporated herein by reference in its entirety.

The interactive media guidance application may also obtain the advertisement data associated with the played media by monitoring, for example, the channel that the user is viewing. The interactive media guidance application, using this information (e.g., channel information) and the current time, may access a database (e.g., a database in data source 124) that contains the interactive media guidance application data for the channels that are available to the user to obtain the desired advertisement data. For example, when the user is viewing channel five, the interactive media guidance application may check the database and, from the interactive media guidance application data associated with channel five, determine which advertisements will be displayed and the advertisement data associated with those advertisements (e.g., to identify images or video clips associated with the advertisements for channel 5).

Data source 124 or advertisers may provide unique identifiers for the advertisement data and/or for the advertisements. The interactive media guidance application, using the unique identifiers, may then associate advertisement data with particular advertisements. The unique identifiers may be any suitable identifiers such as, for example, an arbitrary number or character string, a word or phrase related to the advertisement (e.g., advertisement title, advertiser name, product name), time stamp, or any other suitable identifier.

The advertisement data associated with the advertisements may include identifiers, URLs, interactive media guidance application commands, feature access information, metadata, images or video clips (links therefore), or any other suitable data related to the advertisement. In some embodiments, the advertisement data may include substitute media for the interactive media guidance application to display instead of the associated advertisement when the user skips the advertisement in a recording or during trick play. For example, the advertisement data may include substitute media such as an image (e.g., gif, jpeg, or MPEG I-frame), a series of images forming a shortened advertisement, a video clip, or any other suitable media for displaying while skipping an advertisement. In some embodiments, the advertisement data may include information related to the length of the advertisement (e.g., a reference to the final frame or a time stamp) to identify the end of the advertisement in a recording. The advertisement data may include a flag that identifies the video frames of an advertisement.

In some embodiments, advertisement data may include instructions for the interactive media guidance application to execute upon receiving a skip instruction while viewing a particular advertisement. These instructions may include, for example, instructions to prevent the user from fast-forwarding through or skipping past media, to display substitute images when a user attempts to skip an advertisement or perform any other suitable operation.

In some embodiments, the advertisement data may be associated with non-advertisement media. Such data may include instructions to record certain portions of media that is being played to create a video summary of the media (e.g., when the media is not an advertisement). For example, when the user is viewing a sporting event, the interactive media guidance application may be instructed by the data associated with the sporting event to record replays (i.e., the second showing of a play just viewed) of a “great play” as the replay is presented for the second time. This way, a collection of “great plays” may be compiled and stored by the interactive media guidance application and substituted upon pause or skip to provide a video summary highlighting the best plays of the game. In some embodiments, the collection may be displayed in response to a “highlights” or “preview” instruction.

In some embodiments, instant replays (e.g., identified using instant replay tags) or other portions of a program (e.g., key moments of a series identified using media data) may be recorded to produce short summaries of the media. The media data may identify which portions of the program to record based on a user or system selected temporal compression (e.g., summarize a 1 hour program into 15 minutes, 10 minutes or 5 minutes). In some embodiments, the summary feature for live media may only be activated in response to a trick play instruction from the user (e.g., pause). The summary may then serve as a “screen saver” function that includes the key plays or moments of the media that were transmitted while the user paused the media. This feature may be particularly useful for providing recaps and summaries of sporting events.

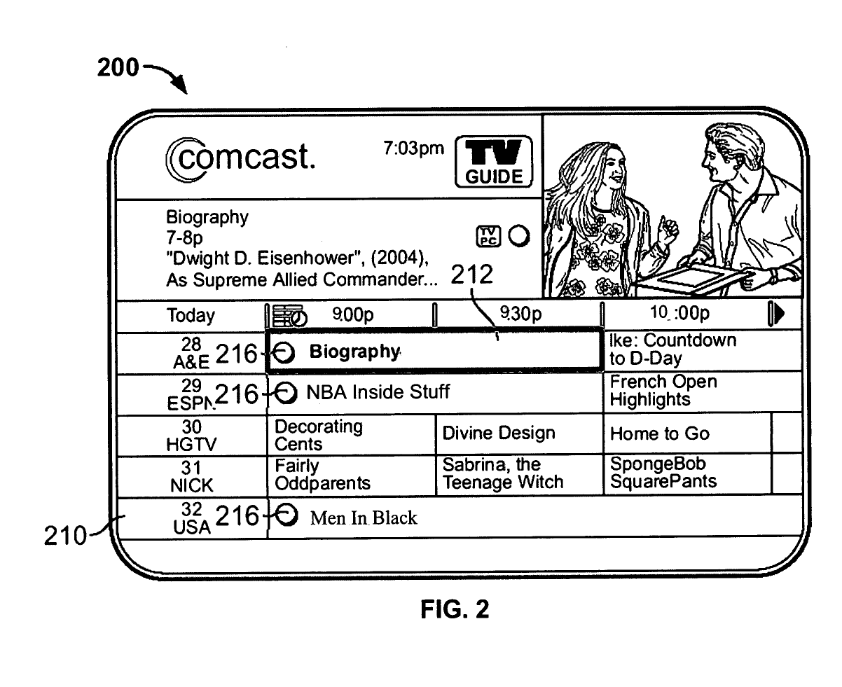

FIG. 2 shows illustrative interactive media guidance application screen 200 that may be displayed on display 112. The user may access interactive media guidance application screen 200 by any suitable means such as, for example, pressing a “menu,” “guide,” or other suitable key or key sequence on user input device 114, navigating from another interactive media guidance application screen or menu, or by any other means known in the art. Illustrative interactive media guidance application screen 200 contains a grid of program listings 210, which includes program titles, channels and scheduled broadcast times. The screen may include any other suitable program information. In other embodiments, the interactive media guidance application screen may include a list (i.e., a single column) of programs. The user may select a desired program listing with highlight region 212 using user input 116, or any other suitable means.

To schedule a program or other suitable video for recording, a user may highlight a desired program, as shown in FIG. 2 where “Biography” on channel 28 is highlighted, and press a “Record” key or key sequence, or select a “Record” option from the screen using user input device 114 (FIG. 1). Any suitable device from user equipment 110 (FIG. 1), for example recording device 118 (FIG. 1), may record the program. In response to receiving an instruction to record the program, the interactive media guidance application may place icon 216 on the listing associated with the selected program to indicate to the user that the interactive media guidance application has scheduled the program for recording (e.g., in FIG. 2, Biography, NBA Inside Stuff and Men In Black are scheduled for recording).

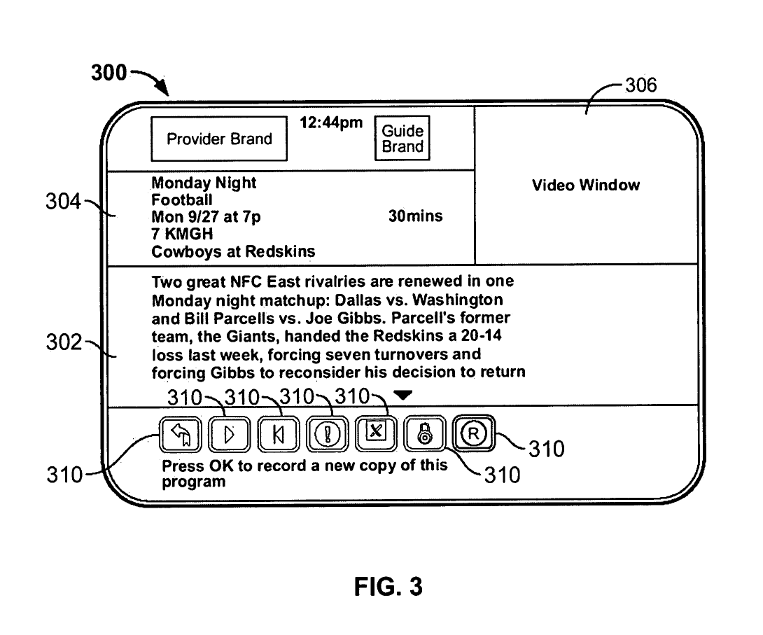

Prior to choosing to record a program, the user may request additional information regarding the program. For example, the user may highlight a listing using highlight region 212 and press an “Information” key or key sequence on user input device 114. In response to receiving the user request, the interactive media guidance application may display an information screen. FIG. 3 shows illustrative information screen 300, which includes detailed information section 302, program description area 304 (including the program title, time and channel), and video window 306. Screen 300 also includes selectable icons 310, some or all of which may include text descriptions. The screen may include options for recording, series recording, parental lock, or any other suitable interactive media guidance application action. If a user determines that he wants to record the program, the user may schedule the recording by pressing a “Record” key or key sequence, selecting a “Record” option from the screen using a user input device (e.g., user input device 114, FIG. 1), or by any other suitable means.

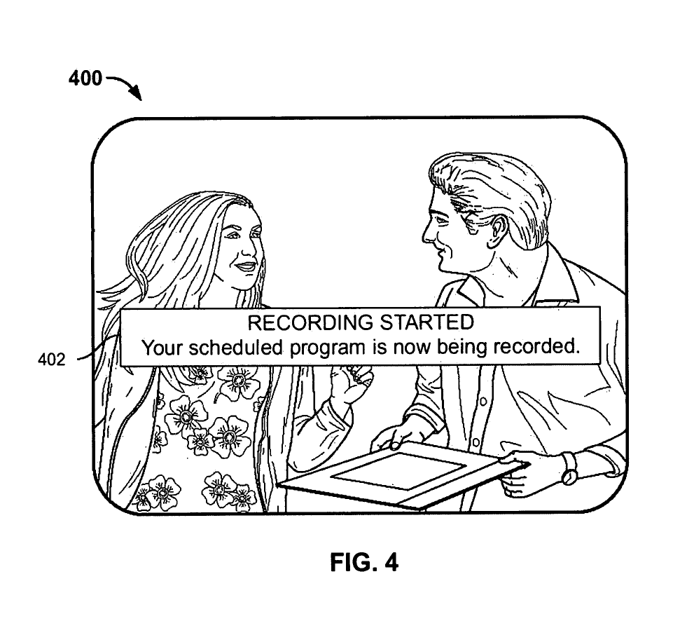

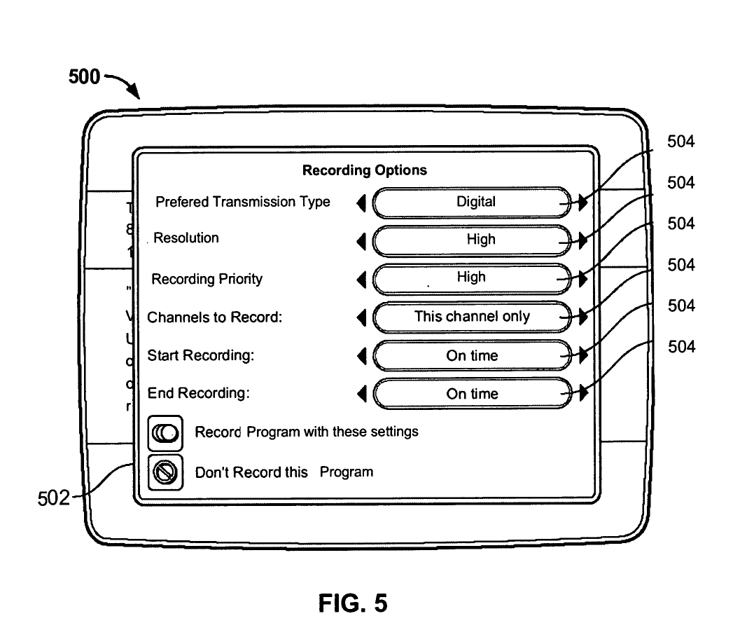

In some embodiments, the user may be watching a program on display device 112 (FIG. 1) in a full screen view, for example full screen view 400 shown in FIG. 4, and decide to record the program. To record the program, the user may press a “Record” key or key sequence on user input device 114 (FIG. 1), or use any other suitable means. A pop-up notice, such as pop-up notice 402, may appear to confirm that recording has begun. Such a notice may also appear in response to receiving a user confirmation to record the program (e.g., in response to a user confirming the recording with menu 502 of FIG. 5). In some embodiments, pop-up notice 402 may appear automatically when a previously-scheduled recording commences.

The interactive media guidance application may prompt the user to set recording options for the program. For example, the interactive media guidance application may display a screen or pop-up, such as recording options screen 500 shown in FIG. 5. Screen 500 includes recording options pop-up menu 502, which includes a plurality of recording options 504. Recording options 504 include the transmission type, resolution, recording priority, start buffer length, when the user intends on viewing the program, and how long to save the copy. In some embodiments, the recording options pop-up menu may include any other suitable recording option (e.g., end buffer length, how many copies to record, and/or which channel(s) to record). In some embodiments, the interactive media guidance application may automatically set recording options for the program.

The recording device may record a selected program by tuning to the channel or transport stream of the selected program, and recording all of the media that is transmitted on the channel or transport stream during the scheduled transmission time of the program. The recorded media may thus include the selected program, and advertisements displayed during breaks in the program (e.g., during commercial breaks of a sporting event, or every 10 or 15 minutes of a series).

In some embodiments, the recording device may be configured to cache the programs that the user views. For example, the recording device may be configured to cache only specific channels (e.g., favorite channels), or the recording device may be configured to cache every channel that the user views. The cached programs may be available for playback using trick play instructions (e.g., pause, rewind, fast forward), or may be made available like other recorded programs.

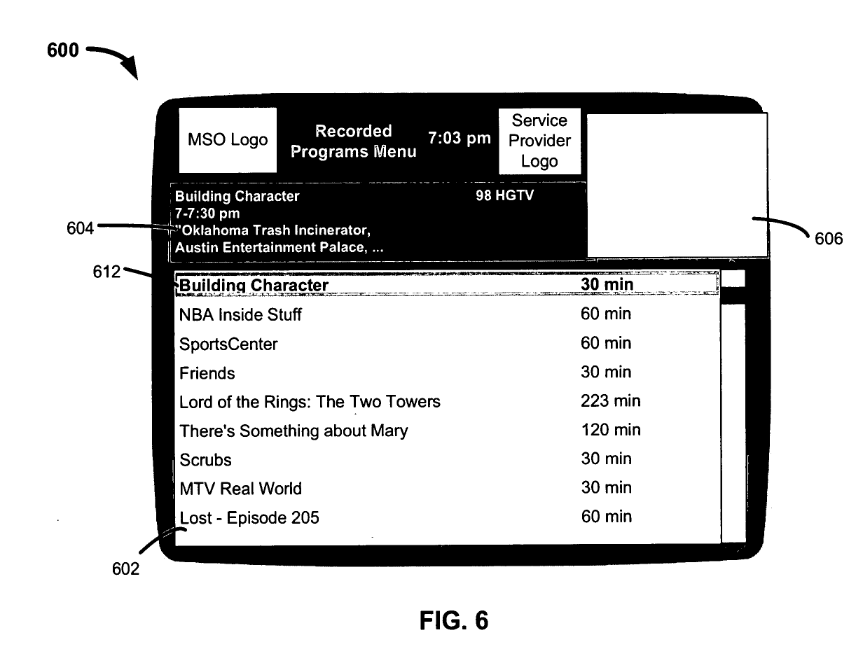

Once the recording device has recorded selected programs, the user may direct the interactive media guidance application to display listings of the recorded programs that the user may select for playback. For example, the user may access a recorded programs menu by pressing a “Recorded Programs Menu” key or key sequence, navigating from another interactive media guidance application screen (e.g., selecting a “Recorded Programs Menu” option from an interactive media guidance application screen using user input device 114, FIG. 1), or by any other suitable means. Recorded programs menu 600, shown in FIG. 6, shows an illustrative display of recorded program listings. Menu 600 includes recordings listings 602, detailed information section 604 and video window 606. Listings 602 include the program title and program length. The listings may include any other suitable information (e.g., channel number).

To play back a recording, the user may select the listing (e.g., using highlight region 612) associated with the recording from listings 602 and press a “Play” key or key sequence on the user input device, select a play option from an interactive media guidance application screen, or perform any other suitable step to initiate playback. In response to the user request, the interactive media guidance application may direct the user's equipment to play back the recording by, for example, directing the recording device (e.g., recording device 118) to provide the appropriate video and audio streams to the display device (e.g., display device 112) to display the selected recording.

Many programs may have been recorded with advertisements. When the programs are played back, the recorded advertisements may also be played back as part of the recording. To avoid viewing an advertisement, the user may either fast forward past the advertisement, or skip the advertisement. In some embodiments, the user may also skip advertisements when the trick playing a program. For example, after pausing, the user may resume play back and skip past advertisements until the user reaches the end of the cache. The following discussion will describe various embodiments of this invention in the context of recorded programs. It will be understood, however, that the embodiments and features discussed may also be implemented in the context of trick play and on-demand media.

The user may instruct the interactive media guidance application to fast forward the recording, for example to fast forward past a commercial, in any suitable manner. For example, the user may press a “fast forward” key on the user input device (e.g., user input device 114) to initiate fast forwarding the recording. The interactive media guidance application may then fast forward the display of the recording (e.g., by displaying every other frame, every third frame, or every tenth frame) until the user presses a “play” key to resume playback of the recording. As another example, the user may press and hold a “fast forward” key on the user input device (e.g., user input device 114). While the “fast forward” key is held, the interactive media guidance application may fast forward the display of the recording. Once the user releases the “fast forward” key, the interactive media guidance application may resume playback of the recording.

To skip an advertisement, the user may press a “skip” key on the user input device (e.g., user input device 114) while an advertisement is being played back. In response to the skip instruction, the interactive media guidance application may identify the time or video frame at which the advertisement ends, and automatically continue playing back the recording from the identified time or video frame. For example, the interactive media guidance application may use advertisement data associated with the advertisement (e.g., advertisement data in-band to the advertisement itself) to identify the time or video frame at which the advertisement ends. As another example, a flag may be associated with the video frames of an advertisement (e.g., from in-band advertisement data). To skip the advertisement, the interactive media guidance application may identify the first video frame of the recording that follows the current playback position and that does not include the advertisement flag, and resume playback from the identified video frame.

While users may find a skipping function more attractive than a fast forward function (e.g., because skipping requires fewer user interactions and may be faster than fast forwarding), advertisers would rather that users not be able to skip their advertisements and cause the investment in the advertisements to be wasted. To allow the users access to skipping functionality while responding to the advertisers' concerns, the interactive media guidance application may provide the skip function with a modification.

In some embodiments, the user may access the modified skip function when the playback stream reaches an advertisement. The user may direct the interactive media guidance application to skip the advertisement in any suitable manner. For example, the user may select a “skip” button on the user input device. As another example, the user may select a skip option from a transport control bar, which may appear in response to a user selecting a menu option or a recording navigation (e.g., pause, fast forward, or reverse) option. For example, illustrative display screen 700 includes video 702 and transport control bar 710, which includes navigation control options 712 (rewind), 714 (play/pause), 716 (stop), 718 (fast forward) and 720 (skip).

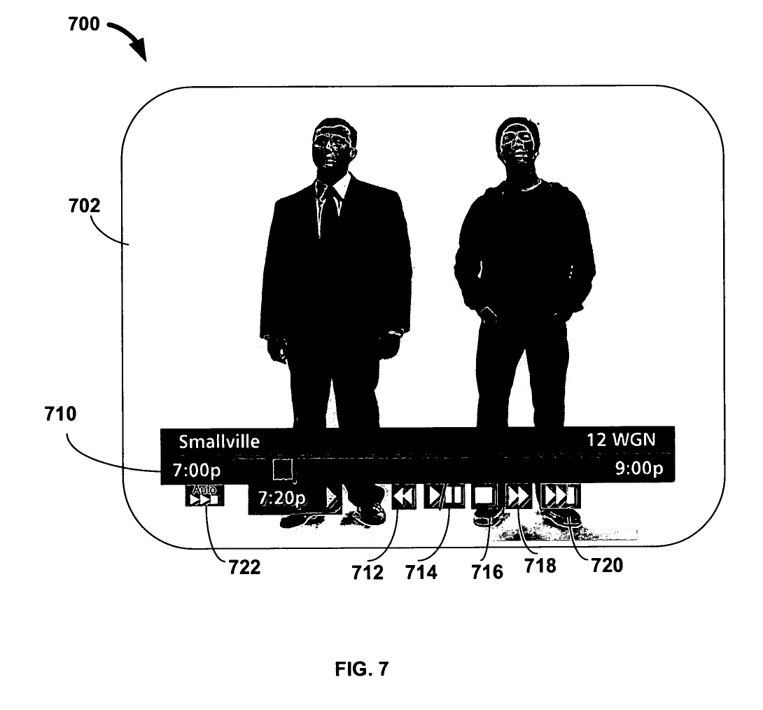

In some embodiments, the skip option may only appear when the currently displayed media is an advertisement. For example, the interactive media guidance application may determine from interactive media guidance application that the currently displayed video frame is an advertisement (e.g., from a flag associated with the video frames of advertisements). In the example shown in FIG. 7, the interactive media guidance application is displaying an advertisement for Mac computers.

In some embodiments, the interactive media guidance application may provide the user with an auto skip function. The auto skip function may be configured to automatically skip all advertisements in a recording. The user may enable this function in any suitable manner including, for example, selecting an on-screen option (e.g., option 722), pressing a key or key sequence on a user input device (e.g., user input device 114, FIG. 1), in a setup menu, or using any other suitable approach. Similarly, the user may disable the auto skip feature in a similar manner.

In response to receiving a skip instruction, the interactive media guidance application may identify the advertisement data associated with the skipped advertisement. For example, control circuitry 116 (FIG. 1) may extract advertisement data placed in-band with the recording. As another example, control circuitry 116 may extract advertisement data from a data stream associated with the advertisement. The data stream may be recorded with the program (e.g., as a separate component stream associated with the program for an MPEG-2 program), or the control circuitry may identify a data stream from data stored with the recording (e.g., in-band) and tune to the identified data stream to receive the advertisement data. The interactive media guidance application may identify which advertisement data is associated with the current advertisement from a unique identifier shared by the advertisement and its advertisement data.

The interactive media guidance application may identify, from the advertisement data, an image, a frame from the advertisement, a video clip, a logo, or any other media configured for display instead of the advertisement. The interactive media guidance application may also identify, from the advertisement data, the length of time that the substitute media should be displayed (e.g., for a 30-second advertisement, display the substitute image for 5 seconds). For example, the display length for the substitute media generally will not exceed the time it would take for the user to fast-forward past the commercial. In some embodiments, fast forward is disabled during advertisement or limited in speed so the skip operation with advertisement (i.e., one embodiment of this invention) may become a preferred operation for the user when advertisements are encountered.

The interactive media guidance application may also identify, from the advertisement data or from the recording itself, the video frame at which the recording should resume once the advertisement has been skipped. For example, the interactive media guidance application may identify flags associated with the advertisement (e.g., in-band) to determine when an advertisement is finished. As another example, if the advertiser has not provided any media information for identifying the end frame of the advertisement, the interactive media guidance application may estimate the length of the advertisement, and skip to a video frame that follows the estimated length (e.g., if the interactive media guidance application estimates that an advertisement lasts 30 seconds, the interactive media guidance application may resume playback 30 seconds after the beginning of the advertisement).

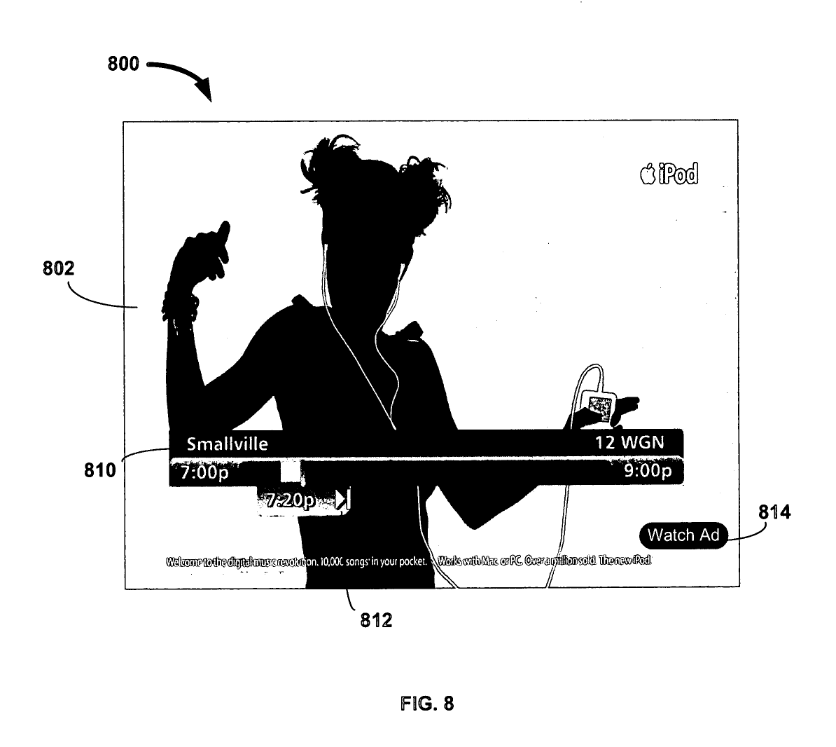

In some embodiments, the advertisement data may include instructions specifying the configuration in which the substitute media should be displayed. The advertisement data may identify any of a plurality of suitable display configurations for the substitute media. FIGS. 8-10 show illustrative display configurations for the substitute media while an advertisement is skipped.

FIG. 8 shows illustrative display screen 800. The interactive media guidance application may display illustrative display screen 800 in response to a user selecting the skip option. Display screen 800 includes full screen overlay 802 that is displayed instead of the recorded advertisement (e.g., video 702, FIG. 7). In the example of FIG. 8, overlay 802 depicts the well-known shadow dancer that is an easily recognized icon of the advertising campaign of the iPod media player consumer product of Apple Computer, Inc., of San Jose, Calif. It also depicts the ipod logo. The substitute media displayed in overlay 802 may be an image, a video frame from the advertisement, a logo, a graphic, a shorter video or advertisement, or any other suitable substitute media instead of the original advertisement. The advertiser may select particular substitute media to entice the user to view the advertisement in its entirety (e.g., by showing an attractive image, or a video clip of an introduction to the advertisement) and/or to purchase the product or service being advertised. In some embodiments, the substitute media displayed may be unrelated to the skipped advertisement.

Screen 800 includes transport control bar 810, which includes skip icon 812 to indicate to the user that the interactive media guidance application is skipping the current advertisement. If the user decides, while the substitute media is displayed, to view the advertisement in its entirety, the user may select an option to view the advertisement, for example option 814. This option may serve as a shortcut for the user (e.g., replacing the need for the user to rewind back to the beginning of the advertisement and start it from the beginning once it has been fully or partially skipped through).

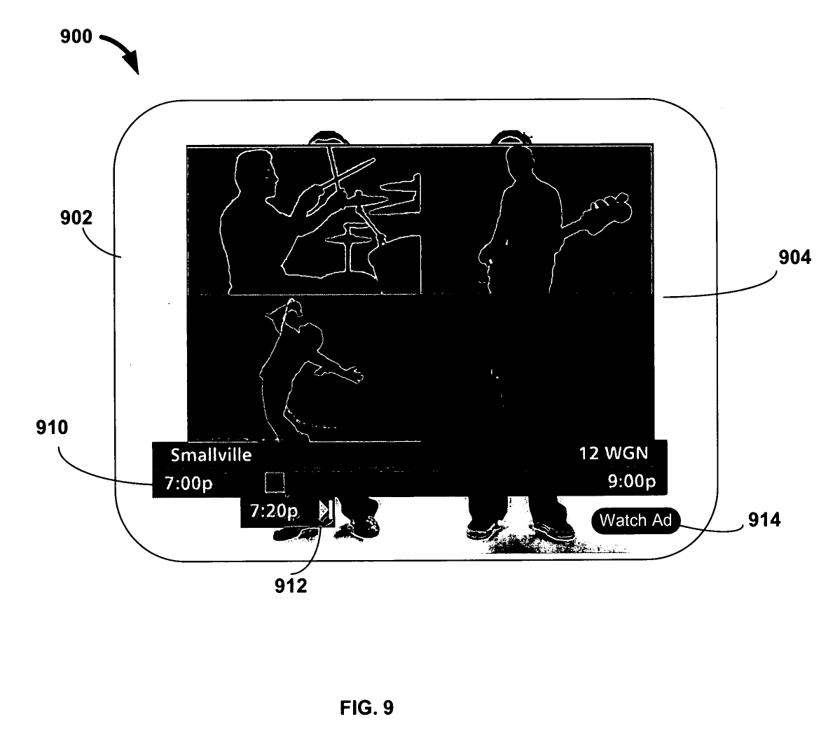

FIG. 9 shows illustrative display screen 900. The interactive media guidance application may display illustrative display screen 900 in response to a user selecting the skip option. Display screen 900 includes partial overlay 904 that is displayed over recorded video 902. In some embodiments, video 902 may be on-demand media or media that has been stored in a trick play cache. Also, the displayed media may be an advertisement that the user skips. The substitute media displayed in overlay 904 may be any of the substitute media of overlay 804. The interactive media guidance application may display any suitable portion of the recording, or any other suitable image or graphic in video 902. For example, the interactive media guidance application may continue to display the video frame that was displayed (i.e., part of the advertisement) when the skip instruction was received. As another example, the interactive media guidance application may display the video frame of the recording that immediately precedes the end of the skipped advertisement. As still another example, the interactive media guidance application may display an interactive media guidance application graphic.

Screen 900 includes transport control bar 910, which includes skip icon 912 to indicate to the user that the interactive media guidance application is skipping the current advertisement. If the user decides, while the substitute media is displayed, to view the advertisement in its entirety, the user may select an option to view the advertisement, for example option 914. This option may serve as a shortcut for the user (e.g. instead of requiring the user to rewind back to the beginning of the advertisement once it has been skipped).

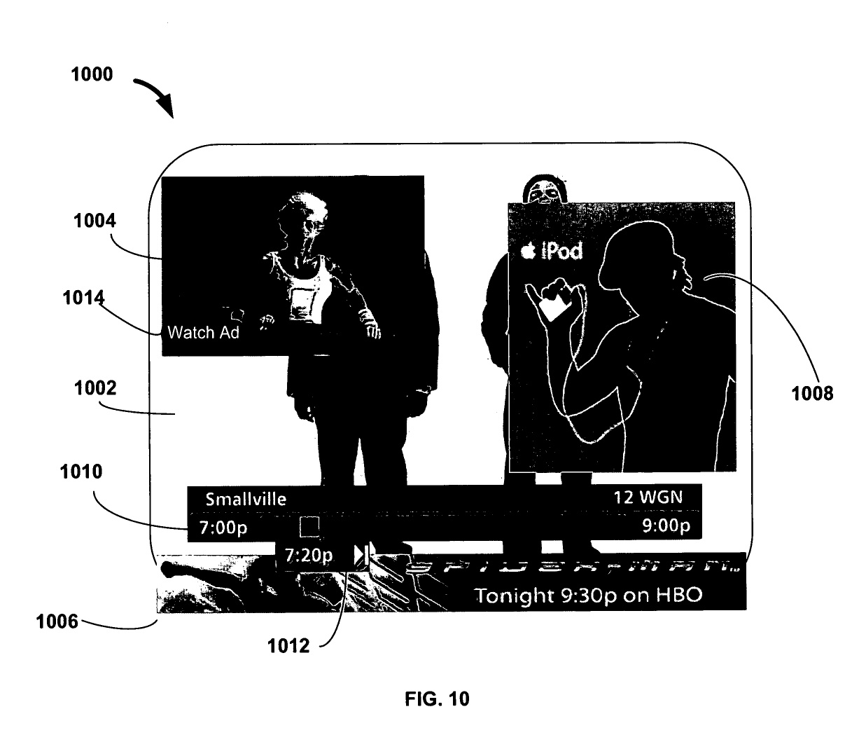

FIG. 10 shows illustrative display screen 1000. The interactive media guidance application may display illustrative display screen 1000 in response to a user selecting the skip option. Display screen 1000 includes picture-in-picture (PIP) window 1004 that is simultaneously displayed with or over main window 1002 (e.g., used to display the recording). The PIP window may be automatically displayed in response to a user instruction to skip an advertisement. The interactive media guidance application may display the substitute media in one of the PIP window or in the main window, and the recording in the other. The substitute media displayed in screen 1000 (e.g., in PIP window 1004 or main window 1002) may be any of the substitute media of overlays 804 and 904. The interactive media guidance application may display any suitable portion of the recording, or any other suitable image or graphic in main window 1002 or PIP window 1004. For example, the interactive media guidance application may continue to display the video frame that was displayed when the skip instruction was received. As another example, the interactive media guidance application may display the first or Nth video frame of the skipped advertisement. As still another example, the interactive media guidance application may display an interactive media guidance application graphic or display screen.

Screen 1000 may include one or more additional advertisements. For example, screen 1000 includes banner ad 1006 and panel ad 1008. The advertisements of banner ad 1006 and panel ad 1008 may be for products or services related to the skipped advertisement, or to other products or services not related to the skipped advertisement. In the example shown in FIG. 10, the skipped advertisement is an advertisement for Mac computers. The advertisement displayed in PIP window 1004 is a short video advertisement for Apple, Inc. The advertisement of panel ad 1008 is an advertisement for the ipod. The advertisement of banner ad 1006 is for a program that the user may view on user equipment 110 (FIG. 1). In some embodiments, the user may select banner ad 1006 and/or panel ad 1008 to view additional information, order a product or service, perform an interactive media guidance application function (e.g., schedule a recording or a reminder), or any other suitable action.

Screen 1000 includes transport control bar 1010, which includes skip icon 1012 to indicate to the user that the interactive media guidance application is skipping the current advertisement. If the user decides, while the substitute media is displayed, to view the advertisement in its entirety, the user may select an option to view the advertisement, for example option 1014. This option may serve as a shortcut for the user (e.g. instead of rewinding back to the beginning of the advertisement once it has been skipped). In various embodiments, to provide feedback to the user that the skip function is in progress, a message (e.g., “Skip in progress . . . ”) or an indication (e.g., an animation of someone skipping from right to left across the screen) may be displayed in addition to or in lieu of the transport control bar.

Once the interactive media guidance application has displayed the substitute media, the interactive media guidance application may return to the recording, and continue playing back the recording from a video frame that follows the skipped advertisement.

In some embodiments, some of the embodiments described above may be implemented in an on-demand environment. An on-demand stream may provide advertisements to the user in any suitable manner. For example, at an appropriate commercial opportunity, the interactive media guidance application may tune away from the on-demand stream, and tune to an advertisement stream. Once the interactive media guidance application has displayed a sufficient number of advertisements from the advertisement stream, the interactive media guidance application may return to the on-demand stream to resume displaying the on-demand media. As another example, advertisements may be incorporated in the on-demand stream, and displayed with the on-demand media when they appear in the stream.

In response to a user request to skip an advertisement, the interactive media guidance application may use any suitable approach for providing substitute media. For example, the interactive media guidance application may access substitute media based on advertisement data associated with the skipped advertisement, as discussed above. As another example, the interactive media guidance application may access and display substitute media from a media stream provided by the on-demand server or by the media source. As another example, the interactive media guidance application may derive substitute media from the advertisement itself. In another embodiment, the interactive media guidance application may always select a specific sub-portion of the advertisement (e.g., the first three seconds of an advertisement) to display when the full advertisement is skipped.

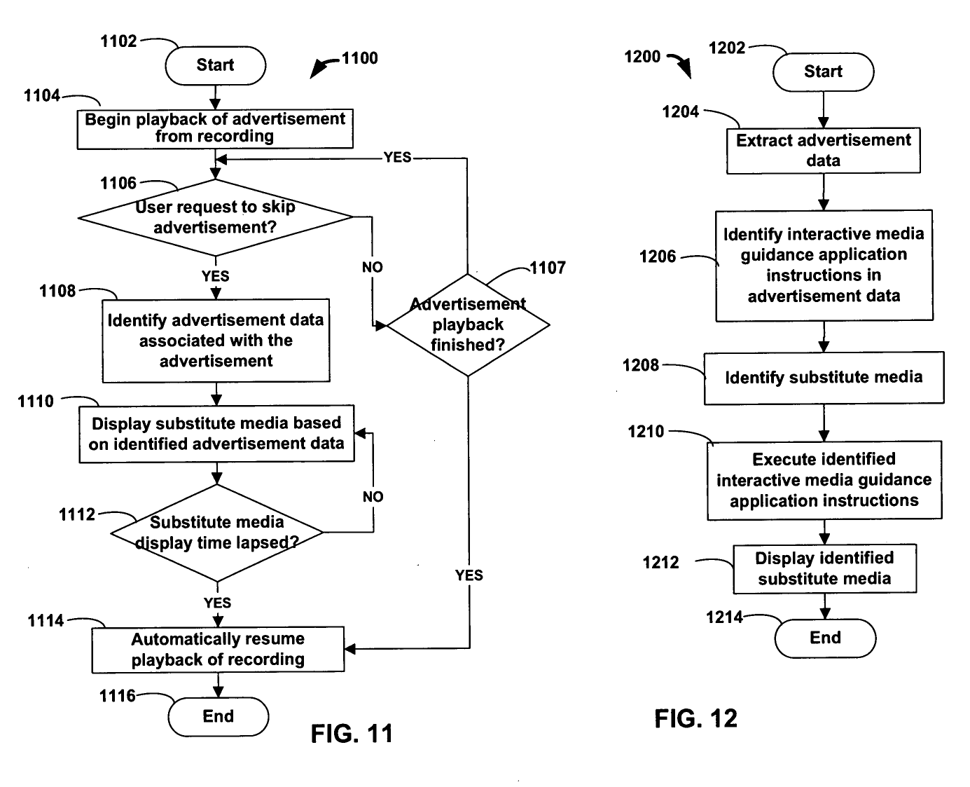

The following flow charts serve to illustrate processes involved in some embodiments of this invention. The flow charts describe processes in the context of recorded programs. It will be understood, however, that these processes may also be applied to on-demand media and to media that is cached in a trick play buffer. FIG. 11 is a flow chart of an illustrative process for displaying substitute media in response to a skip instruction. Process 1100 begins at step 1102. At step 1104, the interactive media guidance application plays back a recording. For example, the interactive media guidance application may receive a user selection of a recorded program listing from user input device 114 (FIG. 1), and direct recording device 118 (FIG. 1) to provide the selected program to display device 112 (FIG. 1) for display.

At step 1106, the interactive media guidance application determines whether the user has instructed the interactive media guidance application to skip an advertisement in the recording. For example, the interactive media guidance application may determine whether the user has pressed a skip key on user input device 114 or selected a skip option displayed on display device 112. As another example, the interactive media guidance application may determine whether the auto skip function is enabled. If the interactive media guidance application determines that the user has not provided a skip instruction, process 1100 moves to step 1107. At step 1107, the interactive media guidance application determines whether the playback of the advertisement has completed. If playback has completed, process 1100 moves to step 1114, where playback of the recording is resumed substantially immediately following the end of the advertisement. If playback has not completed, process 1100 returns to step 1106 to continue to monitor user interactions with the recording (e.g., whether the user initiates a skip request for the advertisement).

If, at step 1106, the interactive media guidance application instead determines that the user has provided an instruction to skip an advertisement, process 1100 moves to step 1108. At step 1108, the interactive media guidance application identifies advertisement data associated with the advertisement. For example, control circuitry 116 (FIG. 1) may extract advertisement data encoded in band or out of band of the recording. As another example, control circuitry 116 may access advertisement data from a data stream that was recorded with the program. As still another example, control circuitry 116 may identify a link or address for a data stream (e.g., from in-band data or from an out-of-band data stream) and acquire advertisement data by tuning to and receiving the data stream. The interactive media guidance application may identify the particular advertisement data identified with the skipped advertisement from a unique identifier that is associated with both the advertisement data and the advertisement. Alternatively, if no substitute media is associated with the advertisement, a system default substitute advertisement may be accessed and displayed.

The interactive media guidance application may identify, from the advertisement data, an image, a frame from the advertisement, a video clip, an audio clip, a logo, or any other substitute media. The substitute media may be part of the recording (e.g., in-band or in an out-of band data stream), or stored elsewhere and accessible by the interactive media guidance application (e.g., stored in data source 124, FIG. 1, and provided in response to an interactive media guidance application request). The interactive media guidance application may also identify, from the advertisement data, a display length for displaying the substitute media (e.g., 5 seconds).

At step 1110, the interactive media guidance application displays, based on the identified advertisement data, substitute media instead of the advertisement. The interactive media guidance application may display the substitute media in any suitable configuration including, for example, an overlay, a partial overlay, in a PIP window, a banner ad, a panel ad, or in any other suitable configuration.

At step 1112, the interactive media guidance application determines whether the time for displaying the substitute media has lapsed. For example, the interactive media guidance application may determine from the advertisement data the length of time that the substitute media should be displayed (e.g., the display length for the substitute media). The advertisement data may indicate that substitute media is to be displayed for no longer than the time it would take a user to fast forward past the advertisement. For example, if the recording device supports up to 10× fast forwarding, the substitute media may be displayed for no longer than 1/10 of the length of the advertisement (e.g., 3 seconds for a 30 second advertisement). If the interactive media guidance application determines that the display time of the substitute media has not reached the display length, process 1100 returns to step 1112 and continues to display the substitute media. In embodiments where the substitute media has an associated length (e.g., the duration of a video or audio clip), the display time is set to the associated length so that the substitute media is displayed in its entirety. In other embodiments, the display time may not a function of any characteristic of the substitute media or the advertisement data (e.g., when the substitute media is a static image).

If, at step 1112, the interactive media guidance application instead determines that the display time of the substitute media has reached the display length, process 1100 moves to step 1114. At step 1114, the interactive media guidance application ceases to display the substitute media, and automatically resumes playback of the recording substantially at a point in the recording just past the end of the advertisement. The interactive media guidance application may display the recording from any video frame that follows the skipped advertisement (e.g., the first frame following the advertisement). Process 1100 then ends at step 1116.

FIG. 12 is a flow chart of an illustrative process for processing advertisement data. In some embodiments, process 1200 may correspond to step 1106 and 1108 of process 1100. Process 1200 begins at step 1202. At step 1204, the interactive media guidance application extracts advertisement data associated with an advertisement. For example, control circuitry 116 (FIG. 1) may extract advertisement data stored in-band or out-of-band with the recording. As another example, control circuitry 116 may access data from a data stream recorded by recording device 118 (FIG. 1) (e.g., recorded at the same time as the program). As still another example, control circuitry 116 may identify a data stream from a link stored with the recording (e.g., in band, out of band, or in a recorded data stream), and tune to or access the identified data stream to receive advertisement data associated with the advertisement.

At step 1206, the interactive media guidance application processes the advertisement data to extract interactive media guidance application commands. The commands stored in the advertisement data may include, for example, commands to display substitute media, how long to display substitute media, the display configuration for substitute media, or any other suitable interactive media guidance application commands. At step 1208, the interactive media guidance application identifies substitute media for display instead of the advertisement. For example, the interactive media guidance application may extract substitute media from the recording (e.g., extract substitute media or graphic rendering instructions from in band or out of band advertisement data, or extract a particular video frame or frame sequence from the video itself) or from a recorded data stream (e.g., recorded with the recording). As another example, the interactive media guidance application may identify the location of substitute media from the advertisement data extracted at step 1206. The advertisement data may indicate, for example, that the substitute media is available from data source 124 (FIG. 1), or that the substitute media is stored in a data stream or in the recording (e.g., at the beginning or end of the recording, in-band, or out-of band).

At step 1210, the interactive media guidance application executes the interactive media guidance application commands identified at step 1206. For example, the interactive media guidance application may select the display configuration for the substitute media, and start a timer for the display length of the substitute media. At step 1212, the interactive media guidance application displays the substitute media identified at step 1208 in accordance with the interactive media guidance application instructions executed at step 1210. Process 1200 then ends at step 1214.

The above described embodiments of the present invention are presented for purposes of illustration and not of limitation, and the present invention is limited only by the claims which follow.

What is claimed is:

1. A method for skipping advertisements, comprising:
playing back video stored at least partially on a storage device, wherein the video includes at least one advertisement;
receiving a user instruction to skip the advertisement;
displaying, in response to receiving the user instruction, substitute media instead of the advertisement; and
automatically resuming playback of the recording from a point that follows the end of the advertisement.

2. The method of claim 1 wherein playing back video stored at least partially on a storage device comprises playing back video partially stored in a cache.

3. The method of claim 1 wherein playing back video stored at least partially on a storage device comprises playing back video entirely stored in a cache.

4. The method of claim 1 wherein playing back video stored at least partially on a storage device comprises playing back a recording entirely stored in a recording device.

5. The method of claim 1 wherein playing back video stored at least partially on a storage device comprises playing back an on-demand video entirely stored on the storage device.

6. The method of claim 1 further comprising:
retrieving a length of time for displaying the substitute media; and
displaying the substitute media for the retrieved length of time.

7. The method of claim 6 wherein the length of time for displaying the substitute media does not exceed the time necessary to fast forward past the advertisement.

8. The method of claim 6 wherein retrieving a length of time for displaying the substitute media comprises retrieving the length of time from advertisement data associated with the video.

9. The method of claim 1, wherein the substitute media is one of an image, a single video frame, a graphic, an icon, and a video clip.

10. The method of claim 1 further comprising:
identifying advertisement data associated with the advertisement; and
identifying substitute media from the identified advertisement data.

11. The method of claim 10 further comprising extracting the advertisement data from the video.

12. The method of claim 10 further comprising extracting advertisement data from a data stream associated with the video.

13. The method of claim 10 wherein the advertisement data specifies a layout for displaying the substitute media.

14. The method of claim 1 wherein the substitute media is related to the skipped advertisement.

15. The method of claim 1 wherein the substitute media is not related to the skipped advertisement.

16. The method of claim 1 wherein the substitute media is derived from the video.

17. The method of claim 16 wherein the substitute media includes fewer than all the frames of the advertisement.

18. A system for skipping advertisements, the system comprising a storage device, a display device, and control circuitry, the control circuitry configured to:
direct the storage device to play back video stored at least partially on the storage device, wherein the video includes at least one advertisement;
receive a user instruction to skip the advertisement;
direct the display device to display, in response to receiving the user instruction, substitute media instead of the advertisement; and
direct the storage device to automatically resume playback of the recording from a point that follows the end of the advertisement.

19. The system of claim 18 wherein the control circuitry is further configured to direct the storage device to play back video partially stored in a cache.

20. The system of claim 18 wherein the control circuitry is further configured to direct the storage device to play back video entirely stored in a cache.

21. The system of claim 18 wherein the control circuitry is further configured to direct the storage device to play back a recording entirely stored in a recording device.

22. The system of claim 18 wherein the control circuitry is further configured to direct the storage device to play back an on-demand video entirely stored on the storage device.

23. The system of claim 18 wherein the control circuitry is further configured to:
retrieve a length of time for displaying the substitute media; and
direct the display device to display the substitute media for the retrieved length of time.

24. The system of claim 23 wherein the length of time for displaying the substitute media does not exceed the time necessary to fast forward past the advertisement.

25. The system of claim 23 wherein the control circuitry is further configured to retrieve the length of time from advertisement data associated with the video.

26. The system of claim 18, wherein the substitute media is one of an image, a single video frame, a graphic, an icon, and a video clip.

27. The system of claim 18 wherein the control circuitry is further configured to:
identify advertisement data associated with the advertisement; and
identify substitute media from the identified advertisement data.

28. The system of claim 27 wherein the control circuitry is further configured to extract the advertisement data from the video.

29. The system of claim 27 wherein the control circuitry is further configured to extract advertisement data from a data stream associated with the video.

30. The system of claim 27 wherein the advertisement data specifies a layout for displaying the substitute media.

31. The system of claim 18 wherein the substitute media is related to the skipped advertisement.

32. The system of claim 18 wherein the substitute media is not related to the skipped advertisement.

33. The system of claim 18 wherein the substitute media is derived from the video.

34. The system of claim 33 wherein the substitute media includes fewer than all the frames of the advertisement.
